(19) United States
(12) Patent Application Publication
(10) Pub. No.: US 2017/0203391 A1
(43) Pub. Date: Jul. 20, 2017

(54) 3D Printing Method and Apparatus

(71) Applicant: Aurora Labs Limited, Applecross, Western Australia (AU)

(72) Inventor: David Budge, Applecross, Western Australia (AU)

(73) Assignee: Aurora Labs Limited, Applecross, Western Australia (AU)

(21) Appl. No.: 15/450,604

(22) PCT Filed: Sep. 7, 2015
(86) PCT No.: PCT/AU2015/000547

§ 371 Date: Mar. 6, 2017

(30) Foreign Application Priority Data
Sep. 9, 2014 (AU) 2014903584
Oct. 15, 2014 (AU) 2014904119

(51) Int. Cl. B23K 26/60; B33Y 30/00; B33Y 50/02; B23K 26/342; B22F 3/105; B23K 10/02; B23K 15/00; B33Y 10/00; B22F 1/00

(52) U.S. Cl. CPC B23K 26/60; B33Y 10/00; B33Y 30/00; B33Y 50/02; B22F 1/0081; B22F 3/1055; B23K 10/027; B23K 15/0086; B23K 26/342; B22F 2003/1056; B22F 2003/1057

(57) ABSTRACT

A printing apparatus is for printing a three-dimensional component. The apparatus has an operative surface, an energy source for emitting an energy beam onto the operative surface, at least one supply tube for dispensing powder onto the operative surface and charging means for electrostatically charging the powder and operative surface. The powder is adapted to be melted by the energy beam and charge applied to the powder has an opposed polarity to charge applied to the operative surface.

### FIELD OF INVENTION

The present invention relates to a 3D printing method and apparatus.

More particularly, the present invention relates to a 3D printing method and apparatus for manufacturing integral 3D parts from different source materials, such as different metals.

### BACKGROUND ART

Three-dimensional (3D) printed parts result in a physical object being fabricated from a 3D digital image by laying down consecutive thin layers of material.

Typically these 3D printed parts can be made by a variety of means, such as selective laser sintering, selective laser melting or selective electron beam melting, which operate by having a powder bed onto which an energy beam of light or heat is projected to melt the top layer of the powder bed so that it welds onto a substrate or a substratum. This melting process is repeated to add additional layers to the substratum to incrementally build up the part until completely fabricated.

Many of the existing printing processes are limited by the ability to only produce printed parts from one alloy or mixture of materials at a time. They do not easily permit the printing with different materials between each of the melting steps, e.g. the use of two different metals or metal, plastic, ceramic layers in an alternating sequence. This is due to the time and difficulty involved in replacing the powder bed.

A further example of this problem is encountered in laser engineered net shaping, which operate by doing away with the powder bed and injecting the powder directly into the laser beam and weld pool. The problem with this process is that only a small amount of material is captured by the weld pool and there are difficulties feeding more than one material into the weld pool sequentially. It is not possible to quickly switch between materials to be welded because there is a time lag between when the powder feeder is switched off and the powder stops flowing through the powder feed tube. Likewise there is a similar lag when the powder feeder is switched on. This is due to the flow characteristics of powder though a tube. As a result, switching between materials often causes cross-contaminated due to overlapping flow, which can only be prevented by stopping operation and increasing the delay between feeding the different powders.

Furthermore, the existing printing processes have difficulties in actively controlling the powder deposition rate and the focus of the energy beam such that a large volume of the powder being delivered by the apparatus gets unused.

For proper operation and to eliminate impurities in the printed part, the melting process must occur in a sterile environment. This is currently achieved by conducting the printing process in an inert or non-reactive gas environment, e.g. argon gas. However, many printing processes are limited in that they are unable to adequately provide a gas shield without significant repetitive purging of the gas in the chamber. This is time consuming and wasteful of the argon gas.

It is an object of the invention to suggest a 3D printing method and apparatus, which will assist in at least partially overcoming these problems.

### SUMMARY OF THE INVENTION

According to one aspect of the present invention, there is provided a printing apparatus for printing a three-dimensional component, comprising:

an operative surface;

an energy source for emitting an energy beam onto the operative surface;

at least one supply tube for dispensing powder onto the operative surface, which powder is adapted to be melted by the energy beam; and

charging means for electrostatically charging the powder and the operative surface, whereby the charge applied to the powder has an opposed polarity to the charge applied to the operative surface.

The apparatus may include multiple supply tubes, for dispensing powder onto the operative surface, and supply control means for independently activating each of the supply tubes to permit dispensing of the powder onto the operative surface.

The supply control means may permit powder to be simultaneously dispensed from more than one supply tube, thereby to deposit a powder mixture on the operative surface.

The apparatus may include a supply tube for dispensing an inert powder onto the operative surface to form a powder bed that will not be melted by the energy beam, the powder bed being adapted to support the component.

The apparatus may include electrostatic control means for controlling the flow direction of the electrostatically charged powder exiting the supply tubes.

The printing apparatus may include at least one waste hopper, wherein each waste hopper is associated with a unique supply tube for receiving, from its associated supply tube, any powder not dispensed onto the operative surface.

The apparatus may include a common nozzle, wherein powder from each supply tube is dispensed onto the operative surface via the common nozzle.

The common nozzle may comprise a plurality of subnozzles, wherein each subnozzle comprises a supply inlet associated with one supply tube, a waste outlet associated with a waste tube, and a dispensing outlet.

Each subnozzle may comprise a shutter valve for selectively closing or opening the dispensing outlet and selectively enabling or disabling flow communication between the supply inlet and waste outlet.

The printing apparatus may include a heating unit for heating the printed part, the feed powder and an area surrounding the operative surface.

The heating unit may heat the printed part to a temperature of between 10% and 70% of the operative temperature at the operative surface.

The printing apparatus may include coupling means for improving energy adsorption of energy from the energy beam by the powder.

The coupling means may include a plasma formed on the operative surface, wherein the plasma includes metal ions.

The energy beam may be focused to produce an energy density at the operative surface, wherein the energy density is at least 10 Watts/mm3.

The energy source may be selected from any one of a laser beam, a collimated light beam, a micro-plasma welding arc, an electron beam and a particle accelerator.

The laser beam may be focused to a spot size of less than 0.5 mm2.

The light beam may be focused to a spot size of less than 1 mm2.

The micro-plasma welding arc may be focused to a spot size of less than 1 mm2.

According to one further aspect of the present invention, there is provided a method for printing a three-dimensional component, the method comprising the steps of:

providing at least one supply tube for dispensing powder onto an operative surface;

using charging means to electrostatically charge the powder and the operative surface, such that charge applied to the powder has an opposed polarity to charge applied to the operative surface; and

emitting an energy beam onto the operative surface using an energy source.

### BRIEF DESCRIPTION OF DRAWINGS

The present invention will now be described, by way of example, with reference to the accompanying drawings, in which:

FIG. 1 is a side view of a schematic layout for a 3D printing apparatus according to a first embodiment of the invention;

FIG. 2 is an enlarged view of a schematic layout for a feed nozzle for use in the printing apparatus shown in FIG. 1;

FIG. 3 is a perspective view of a schematic layout for a 3D printing apparatus according to a second embodiment of the invention; and

FIG. 4 is a side view of the 3D printing apparatus shown in FIG. 3.

### DETAILED DESCRIPTION OF THE DRAWINGS

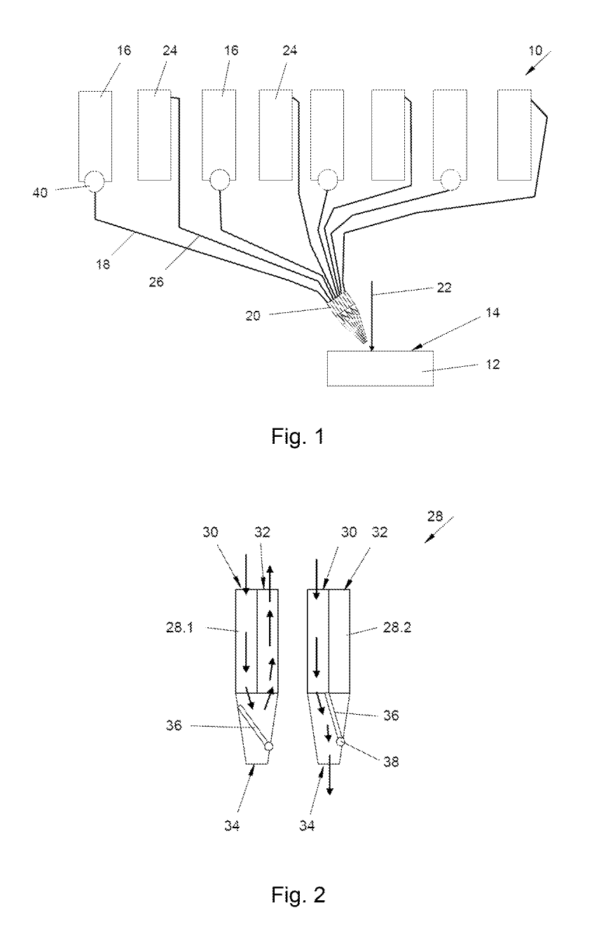

Referring now to FIGS. 1 and 2 of the drawings, there is shown a schematic layout for a 3D printing apparatus in accordance with a first embodiment of the invention, being generally indicated by reference numeral 10. The apparatus 10 includes a substrate 12 having an operative surface 14 on which a printed part can be fabricated by 3D printing. It is to be understood that initially the operative surface 14 will be located directly on the substrate 12, but that as the printed part is fabricated the operative surface 14 will be located on a substratum of the printed part.

The apparatus 10 includes a number of supply hoppers 16 containing powder that flows from each of the supply hoppers 16 through their supply tubes 18 to a common nozzle 20 to be dispensed therethrough onto the operative surface 14 where an energy beam 22 (emitted by an energy source) heats and melts the powder thereby to form the printed part. Initially the powder is deposited and melted directly onto the substrate 14 but, as the printed part is fabricated by addition of subsequent layers, the powder is deposited and melted onto a substratum of the printed part.

It is envisaged that each of the supply hoppers 16 will contain a powder of a different material, e.g. one supply hopper 16 can contain a stainless steel powder, another supply hopper 16 can contain brass powder, whilst a further supply hopper 16 can contain a non-reactive inert powder.

The energy beam 22 can be any one of a laser beam, a collimated light beam, a micro-plasma welding arc, an electron beam and a particle accelerator. Preferably the energy beam 22 has focusing means (not illustrated) being adapted to suitably focus the energy beam 22 so that an energy density being at least 10 Watts/mm³ is produced on the operative surface 14.

Where the energy beam 22 is a laser beam, the laser beam can be focused onto the operative surface 14 to a spot size of less than 0.5 mm². Similarly, where the energy beam 22 is a collimated light beam, the light beam can be focused onto the operative surface 14 to a spot size of less than 1 mm². Further, where the energy beam 22 is a micro-plasma welding arc, the micro-plasma welding arc can be focused onto the operative surface 14 to a spot size of less than 1 mm². Such a micro-plasma welding arc is normally able to produce a focused beam of plasma gas at a temperature of about 20,000° C. with a spot size of about 0.2 mm².

Both the electron beam and the particle accelerator are similar in operations with the difference being that the electron beam uses high speed electron to melt the metal with the particle accelerator uses high speed atomic nuclei. It is preferable to use the electron beam option because the use of excessively high velocities by the particle accelerator can result in the printed parts being radioactive.

The apparatus 10 further includes a number of waste hoppers 24, wherein each waste hopper 24 is paired with one of the supply hoppers 16, and wherein waste tubes 26 lead from the nozzle 20 to the waste hoppers 24.

The nozzle 20 comprises a number of subnozzles 28, shown in greater detail in FIG. 2, wherein each subnozzle 28 is associated with one pair of the supply tubes 18 and waste tubes 26. The subnozzle 28 has a supply inlet 30, a waste outlet 32 and a dispensing outlet 34. A shutter valve 36 is pivotally located within the subnozzle 28 to selectively close or open the dispensing outlet 34. It is envisaged that any of the subnozzles 28 can be opened concurrently. The shutter valve 36 is joined to the subnozzle 28 at pivot 38.

FIG. 2 shows both a closed subnozzle 28.1 and an open subnozzle 28.2. In the closed subnozzle 28.1 the shutter valve 36 is pivoted to close off the dispensing outlet 34. In this position the supply inlet 30 is in flow communication with the waste outlet 32 and any powder flowing into the subnozzle 28.1 from its supply tube 18 is redirected through the waste outlet 32 to its waste tube 26 for return to its waste hopper 24. However, in the open subnozzle 28.2 the shutter valve 36 is pivoted to open the dispensing outlet 34, while simultaneously closing off the waste outlet 32. In this position the supply inlet 30 is in flow communication with the dispensing outlet 34 and any powder flowing into the subnozzle 28.1 from its supply tube 18 is dispensed onto the operating surface 14.

The flow of the powder within the supply tubes 18 and waste tubes 26 can be by gas feed or by gravity feed. Furthermore, the supply hoppers 16 each have a flow pump 40 for pumping the powder from the supply hoppers 16 into the supply tubes 18.

It is further envisaged that the waste hoppers 24 can be joined to their associated supply hoppers 16 so that the powder can be returned from the waste hoppers 24 to the supply hoppers 16 for re-use. Alternatively, the waste tube 26 can return directly to the supply hopper 16, i.e. in which case no waste hoppers 24 will be needed.

In use, when a supply of powder is required from a specific supply hopper 16, the flow pump 40 is activated, while its shutter valve 36 remains closed, to cause a steady and sufficient flow of powder through the subnozzle 28. When this has been achieved, the shutter valve 36 is opened to enable the powder to be dispensed for use. After the powder is no longer required, the dispensing thereof is stopped by closing the shutter valve 36. Any powder still contained within the supply tube 18 is flushed through the subnozzle 28 and waste tube 26 to the waste hopper 24, whereafter the flow pump 40 is deactivated. Any unused and uncontaminated powder can then be recovered from the waste hopper 24 for reuse.

It is thus apparent that the nozzle 20 is operatively connected to multiple supply tubes 18, each being adapted to supply a unique material from the relevant supply hoppers 16. The interchanging of the specific material powders can be rapidly performed by simply opening or closing the relevant valve 36. Alternatively, it is possible to mix the various powders in a specific ratio by simultaneously opening the valves 36 of two or more subnozzles 28 and while adjusting the relevant powder flow rates imposed by the flow pumps 40.

Accordingly, the present invention allows for multiple metals to be deposited onto the operative surface 14 concurrently, either being deposited adjacent to each other for simultaneously forming different respective parts of a product, or being deposited together in a mixture for forming a metal alloy when melted under the energy beam 22. For example, a component in which it is desired to have a stainless steel outer housing with a brass inner lining may have the stainless steel powder deposited first whereafter the brass powder deposited. Finally, if required for support purposes to support the component during the printing process, any further areas can be filled with any powder, e.g. the stainless steel or brass or an inert powder, to form a powder bed which will not be melted and within which powder bed the component will be formed. The inert powder material can be a commercially cheap powder, e.g. silica, as it will not be part of the area that is melted. After all the powders have been deposited, the energy beam 22 scans the operative surface 14 to melt or sinter the multiple materials in succession. Normally the inert powder remaining powder bed, e.g. the inert powder, not be scanned by the energy beam and will remain unmelted. This sequence is repeated in layers to build up the component containing different materials. Once the printing process is complete, the component can be removed from the loose powder bed.

Due to the nature of powder particles, they often tend to roll across the operative surface 14 when deposited thereon. Thus is normally either due to the shape of the powder particles, e.g. roughly round shaped powder particles that bounce roll on the operative surface and collide with other powder particles already located thereon, or the rolling can be caused by the force of the gas feed carrying the powder particles through the supply tubes 18, or the rolling can be caused by gravity by the powder particles rolling off a “heap” if too many powder particles are deposited at the same position.

This problem of rolling is overcome by electrostatically charging both the powder particles and the operative surface 14 with opposed polarities. For example, a positive charge can be applied to the operative surface 14 and the powder particles exiting the nozzle 20 can be negatively charged. Thus as the powder particles exit the nozzle 20 they are drawn towards the operative surface 14 and, once contact is made therewith, the powder particles stick in place on the operative surface. Advantages of such adhesion is, firstly, that it results in an improved resolution of the final component as the powder particles can be accurately placed and, secondly, that working environment within the printing apparatus is improved as there is less powder particle dust between the nozzle 20 and the operative surface 14. Further, it is also possible to control the direction of flow of the electrostatically charged powder particles using other electrostatic means.

The resolution can further be enhanced by oscillating lens mirrors associated with energy beam 22 within a fixed amplitude across the desired path of the energy beam 22—contrary to the conventional manner of oscillating the mirrors across the entire operative surface 14. The lens mirrors can also be oscillated in multiple orthogonal planes across the operative surface 14.

During the manufacture of some components having a thin wall structure, it may be experienced that the wall structure deforms while the component is being manufactured due to the temperature differential between the cooling component nearer to the substrate 12 and the operative surface 14 subjected to the energy beam 22. It is envisaged that the likelihood of such deformation occurring can be substantially reduced by heating the ambient environment in which the component is printed, e.g. the powder bed, to a temperature being between 30% to 70% of the melting point of the powder being used in the printing apparatus 10.

Also the powder being deposited can be pre-heated.

When a laser is used as the energy beam 22, it may often be found that a large percentage of the energy is deflected or reflected off the powder particles and thus leads to a lower operative efficiency of the apparatus 10. It may be experienced that as little as 5-40% of the energy is adsorbed by the powder particles and thus the printing process is lengthened to properly melt the powder particles. Accordingly, the invention further provides a method of “coupling” of the laser energy to the powder, by creating a plasma on the operative surface 14. This coupling substantially improves the laser energy adsorption, for example from the roughly 40% to 100%. It is beneficial to the coupling method for metal ions to be present in the plasma. These metal ions can be introduced either by vaporisation of a suitable metal with the energy beam 22 or by addition of a suitable organometallic compound into the gas atmosphere (for example iron carbonyl for providing iron ions).

It is envisaged that the apparatus 10 can be scaled up in operative size, such as by providing multiple nozzles 20 and multiple energy beams 22, or by providing larger nozzles 20 for depositing larger volumes of powder and higher powered energy beams 22 to melt the powder. Thereby the apparatus 10 can simultaneously manufacture many discrete components. Alternatively, the apparatus 10 can manufacture a single component of increased size, whereby each of the multiple nozzles 20 and multiple energy beams 22 manufacture a distinct section or part of the single component. The multiple nozzles 20 and multiple energy beams 22 can be arranged to operate sequentially or in parallel to each other.

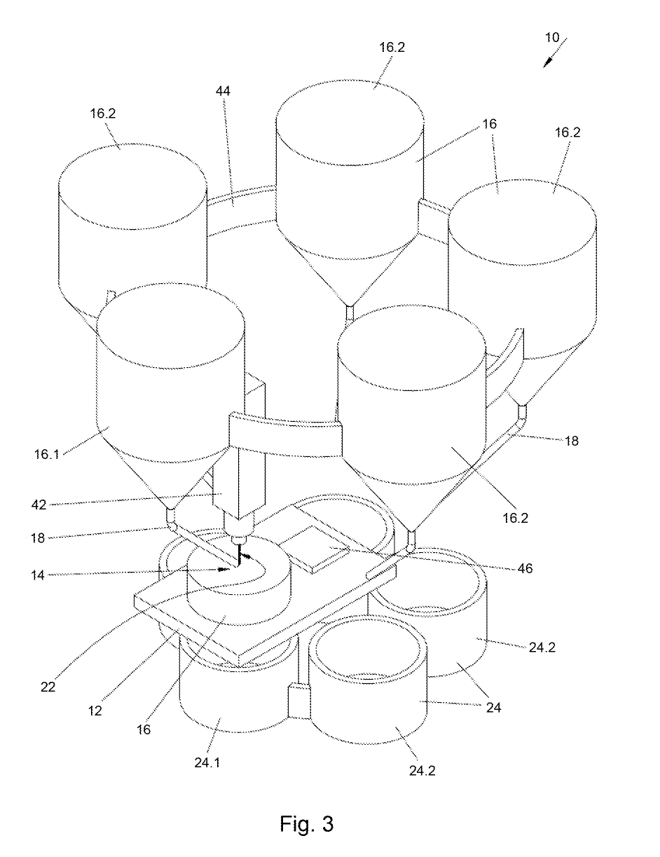

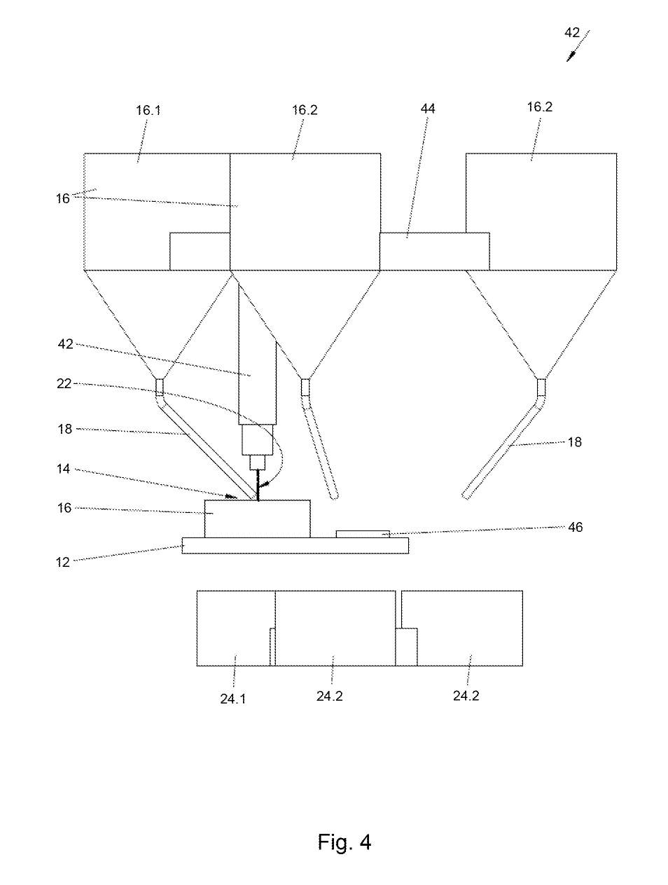

Referring to FIGS. 3 and 4 of the drawings, there is shown a schematic layout for the 3D printing apparatus 10 in accordance with a second embodiment of the invention. The apparatus 10 includes a substrate 12 having an operative surface 14 on which a printed part 16 is to be fabricated by 3D printing. Initially, the operative surface 14 is located directly on the substrate 12, but that as the printed part 16 is fabricated the operative surface 14 will be located on a substratum of the printed part 16.

The apparatus 10 further includes a number of supply hoppers 16 containing powder that flows from the supply hoppers 16 through their supply tubes 18 to be deposited on the operative surface 14 beneath an energy source 42. An energy beam 22 is emitted by the energy source 42 onto the operative surface 14 to heat and melt the powder thereby to form the printed part 16. Initially the powder is deposited and melted directly onto the substrate 12 but, as the printed part 16 is fabricated by addition of subsequent layers, the powder is deposited onto a substratum of the printed part 16.

The supply hoppers 16 are rotatably associated with the substrate 12 so that only one supply hopper 16.1 is able to deposit powder onto the operative surface 14 at a time, while the remaining supply hoppers 16.2 remain idle and non-operative. The rotation of the supply hoppers 16 is done by a motor unit, which is not illustrated in the drawings. In the embodiment shown, the apparatus 10 includes five supply hoppers 16, with the respective supply hoppers 16 being interlinked by a support ring 44. Each of the supply hoppers 16 can contain the same or a different powder as contained in every other supply hopper 16. Where the supply hoppers 16 contain different powders, the rotational replacement of the operative supply hopper 16.1 allows a quick interchange of the different powders deposited onto the operative surface 14. Furthermore, having multiple supply hoppers 16 also allows the idle supply hoppers 16.2 to be refilled if they become empty.

The apparatus 10 further includes a number of waste hoppers 24, wherein each waste hopper 60 is paired with one of the supply hoppers 16. The waste hoppers 24 are also rotatably associated with the substrate 12 and rotate together with the supply hoppers 16. The waste hoppers 24 are located operatively beneath the supply tubes 18 so that any powder flowing out from the supply tubes 18 of the idle hoppers 16.2 is received by the waste hoppers 24.2. While the operative supply hopper 16.1 deposits its powder onto the operative surface, its associated waste hopper 24.1 is located beneath the substrate 12.

The energy source 42 can be any one of a laser beam, a collimated light beam, a micro-plasma welding arc, an electron beam and a particle accelerator. Preferably the energy source 42 has focusing means (not illustrated) being adapted to enable the energy beam 22 to be suitably focused so that an energy density is produced on the operative surface 14, wherein the energy density is at least 10 Watts/mm³.

Where the energy beam 22 is a laser beam, the laser beam can be focused onto the operative surface 14 to a spot size of less than 0.5 mm². Similarly, where the energy beam 22 is a light beam, the light beam can be focused onto the operative surface 14 to a spot size of less than 1 mm². Further, where the energy beam 22 is a micro-plasma welding arc, the micro-plasma welding arc can be focused onto the operative surface 14 to a spot size of less than 1 mm².

Preferably the apparatus 10 also includes a heating unit for heating the printed part 16, the powder contained within the supply hoppers 16 and the substrate 12. The heating unit may be directly attached to the substrate 12. The heating unit is adapted to heat the printed part to a temperature of between 30% and 66% of the operative temperature at the operative surface 14.

According to a further aspect of the present invention, the atmospheric environment surrounding the substrate 12 is sealed and controlled to ensure a pure and non-reactive atmosphere is present during operation so that no impurities are formed within the printed part 16 due to reaction of the powder with impure elements within the atmosphere. In order to obtain a non-reactive atmosphere the apparatus 10 is flushed with an inert or non-reactive gas prior to operation. Preferably the inert gas is a noble gas such as argon, but other non-reactive gases can also be used.

Normally a single flushing will not fully remove all air from the apparatus 10 and thus a small volume of air impurities, i.e. some oxygen and nitrogen, will still remain within the apparatus 10. Thus to avoid the necessity to conduct repetitive flushing with the argon gas, the printing apparatus 10 is provided with a reactive metal base 46, such as titanium, niobium or tantalum. In the illustrated embodiment, the metal base 46 is shown located on but offset to one side of the substrate 12. However, it is also envisioned that the metal base 62 could be located apart from the substrate 12.

The metal base 46 is located in a suitable position where it can be selectively subjected to the energy beam 22. Thus either the energy source 42 or the energy beam 22 can be movable so that it can be moved over the metal base 46 or the substrate 12 can be movable so that the metal base 46 can be moved in under the energy source 42. When the metal base 46 is subjected to the energy beam 22, any air contamination within the atmospheric environment reacts with the metal base 46 to form solid metal oxides and metal nitrides, thereby extracting the air impurities from the atmospheric environment and resulting in a substantially pure argon atmospheric environment.

Modifications and variations as would be apparent to a skilled addressee are deemed to be within the scope of the present invention.

1. A printing apparatus for printing a three-dimensional component, the printing apparatus comprising:
an operative surface;
an energy source for emitting an energy beam onto the operative surface;
at least one supply tube for dispensing powder onto the operative surface, which powder is adapted to be melted by the energy beam; and
charging means for electrostatically charging the powder and the operative surface, whereby charge applied to the powder has an opposed polarity to charge applied to the operative surface.

2. A printing apparatus according to claim 1, further comprising:
multiple supply tubes for dispensing the powder onto the operative surface; and
supply control means for independently activating each of the supply tubes to permit dispensing of the powder onto the operative surface.

3. A printing apparatus according to claim 2, wherein the supply control means permits the powder to be dispensed from more than one supply tube simultaneously, thereby to deposit a powder mixture onto the operative surface.

4. A printing apparatus according to claim 1, further comprising a supply tube for dispensing an inert powder onto the operative surface to form a powder bed that is not melted by the energy beam, the powder bed being adapted to support the three-dimensional component.

5. A printing apparatus according to claim 1, further comprising electrostatic control means for controlling a flow direction of the electrostatically charged powder exiting the supply tubes.

6. A printing apparatus according to claim 1, further comprising at least one waste hopper, wherein each waste hopper is associated with a unique supply tube for receiving, from its associated supply tube, any powder not dispensed onto the operative surface.

7. A printing apparatus according to claim 1, further comprising a common nozzle, wherein powder from each supply tube is dispensed onto the operative surface via the common nozzle.

8. A printing apparatus according to claim 7, wherein the common nozzle comprises a plurality of subnozzles, and each subnozzle comprises a supply inlet associated with one supply tube, a waste outlet associated with a waste tube, and a dispensing outlet.

9. A printing apparatus according to claim 8, wherein each subnozzle comprises a shutter valve for selectively closing or opening the dispensing outlet and selectively enabling or disabling flow communication between the supply inlet and waste outlet.

10. A printing apparatus according to claim 1, further comprising a heating unit for heating the three-dimensional component being printed, the feed powder and an area surrounding the operative surface.

11. A printing apparatus according to claim 10, wherein the heating unit heats the three-dimensional component being printed to a temperature of between 10% and 70% of an operative temperature at the operative surface.

12. A printing apparatus according to claim 1, further comprising a coupling means for improving energy adsorption of energy from the energy beam by the powder.

13. A printing apparatus according to claim 12, wherein the coupling means comprises a plasma formed on the operative surface, wherein the plasma includes metal ions.

14. A printing apparatus according to claim 1, wherein the energy beam is focused to produce an energy density at the operative surface, wherein the energy density is at least 10 Watts/mm³.

15. A printing apparatus according to claim 1, wherein the energy source is a laser beam.

16. A printing apparatus according to any of claim 15, wherein the laser beam is focused to a spot size of less than 0.5 mm².

17. A printing apparatus according to claim 1, wherein the energy source is a collimated light beam.

18. A printing apparatus according to any of claim 17, wherein the collimated light beam is focused to a spot size of less than 1 mm².

19. A printing apparatus according to claim 1, wherein the energy source is a micro-plasma welding arc.

20. A printing apparatus according to any of claim 19, wherein the micro-plasma welding arc is focused to a spot size of less than 1 mm².

21. A printing apparatus according to claim 1, wherein the energy source is an electron beam.

22. A printing apparatus according to claim 1, wherein the energy source is a particle accelerator.

23. A method for printing a three-dimensional component, the method comprising:
providing at least one supply tube for dispensing powder onto an operative surface;
using charging means to electrostatically charge the powder and the operative surface, such that charge applied to the powder has an opposed polarity to charge applied to the operative surface; and
emitting an energy beam onto the operative surface using an energy source.
